(19) United States
(12) Patent Application Publication
(10) Pub. No.: US 2023/0234840 A1
(43) Pub. Date: Jul. 27, 2023

(54) PROCESS FOR THE THERMAL DECOMPOSITION OF AMMONIA AND REACTOR FOR CARRYING OUT THE PROCESS

(71) Applicant: GENCELL LTD., Petah Tikva (IL)

(72) Inventors: Gennadi FINKELSHTAIN, Modiin (IL); Stanislav SHABUNYA, Minsk (BY); Uladzimir KALININ, Minsk (BY)

(21) Appl. No.: 17/997,033

(22) PCT Filed: Apr. 19, 2021
(86) PCT No.: PCT/US2021/027983

§ 371 Date: Oct. 25, 2022

Related U.S. Application Data
(60) Provisional application No. 63/015,755, filed on Apr. 27, 2020.

(51) Int. Cl. C01B 3/04; B01J 19/24; B01J 19/00; H01M 8/04089; H01M 8/0606

(52) U.S. Cl. CPC C01B 3/047; B01J 19/0013; B01J 19/2415; H01M 8/0606; H01M 8/04097; B01J 2219/00099

(57) ABSTRACT

The invention relates to a process for the thermal decomposition of ammonia. The process comprises passing ammonia through a conduit which contains an ammonia decomposition catalyst in a part thereof. At least a section of the part of the conduit which contains the catalyst is immersed in molten lead as heat transfer medium, which is at a temperature at which the catalyst is capable of catalyzing the decomposition of ammonia into hydrogen and nitrogen. A reactor for carrying out this process is also disclosed.

### BACKGROUND OF THE INVENTION

### 1. Field of the Invention

The present invention relates to a process for the catalyzed thermal decomposition of ammonia and a reactor which is suitable for carrying out this process. The ammonia decomposition products can be used, for example, as fuel for a hydrogen fuel cell.

### 2. Discussion of Background Information

One of the environmentally most benign ways of generating energy is the use of hydrogen as fuel, for example in a fuel cell. The only combustion product of a fuel cell, i.e., water apparently does not pose any risks to the environment. However, the main challenge of this technology is to provide the hydrogen fuel in an efficient manner. There is a need to contain a useful quantity of hydrogen in a small volume. Such containment requires either refrigerating the hydrogen until it achieves the liquid state or compressing it to 5,000 psi. Both processes involve considerable expense. Further, the small hydrogen molecules can leak through holes and cracks too small for other molecules and they can diffuse into the crystalline structure of metals and thereby embrittle them. Accordingly, the main obstacle to using hydrogen fuel cells lies in the requirement to store enough hydrogen in an efficient way to make the cell practical.

One approach to overcome the drawbacks of using hydrogen as a fuel is to generate it from a compound that is easier to store and transport than hydrogen in a separate reactor which can be connected to the fuel cell. Ammonia is such a compound. As a fuel ammonia has several advantages over hydrogen and hydrocarbon fuels. For example, ammonia is a common industrial chemical and is used, for example, as the basis for many fertilizers. Producers also transport it and contain it in tanks under modest pressure, in a manner similar to the containment and transport of propane. Thus, there already is a mature technology in place for producing, transporting and storing ammonia. Further, although ammonia has some toxicity when inhaled, ammonia inhalation can easily be avoided because it has a readily detected odor. Ammonia also does not readily catch fire, as it has an ignition temperature of 650° C. If no parts of an ammonia-based power system reach that temperature, then any ammonia spilled in an accident will simply dissipate.

Hydrogen can be generated from the ammonia in an endothermic reaction carried out in a device separate from the fuel cell. Ammonia decomposition reactors (ammonia crackers) catalytically decompose ammonia into hydrogen and nitrogen.

U.S. Pat. Nos. 5,055,282 and 5,976,723, the entire disclosures of which are incorporated by reference herein, disclose a method for cracking ammonia into hydrogen and nitrogen in a decomposition reactor. The method consists of exposing ammonia to a suitable cracking catalyst under conditions effective to produce nitrogen and hydrogen. In this case the cracking catalyst consists of an alloy of zirconium, titanium, and aluminum doped with two elements from the group consisting of chromium, manganese, iron, cobalt, and nickel.

U.S. Pat. No. 6,936,363, the entire disclosure of which is incorporated by reference herein, discloses a method for the production of hydrogen from ammonia based on the catalytic dissociation of gaseous ammonia in a cracker at 500 -750° C. A catalytic fixed bed is used; the catalyst is Ni, Ru and Pt on Al₂O₃. The ammonia cracker supplies a fuel cell (for example, an alkaline fuel cell (AFC)) with a mixture of hydrogen and nitrogen. Part of the supplied hydrogen is burned in the ammonia cracker for the supply of the energy needed for the ammonia dissociation process.

Despite advances in the art, there still is a need for a process that is energy efficient and in which ammonia is decomposed in an efficient way.

There are several important considerations when designing a process and reactor for the catalyzed thermal decomposition of ammonia, especially in cases where the decomposition products are to be used as fuel for a hydrogen fuel cell such as an alkaline fuel cell. For example, the higher the temperature and the lower the pressure the more efficient the equilibrium decomposition of NH₃ will be. According to fuel cell maintenance requirements the pressure has to be near atmospheric, and therefore this parameter may be considered to be fixed. The process temperature has to be chosen in accordance with maintenance conditions of the whole device. It is unnecessary trying to achieve a maximum conversion rate (at equilibrium) if the fuel cell does not use all of the hydrogen from the inbound mixture.

Ideally, the decomposition of two moles of ammonia provides one mole of nitrogen and three moles of hydrogen, i.e., the volume of the mixture increases twofold, and the volume, measured in volume percent is 25% N₂ and 75% H₂. In reality the composition of the decomposition product mixture at equilibrium will be different from an ideal one. For example, at a temperature of 450° C. the composition of the product mixture can be calculated to be 24.94325% N₂, 74.82975% H₂ and 0.227% NH₃ As can be seen, even at 450° C. the residual non-decomposed ammonia is 0.227%, and a continued temperature increase (a decrease in residual ammonia) will have only a small effect on the amount of released hydrogen. If small concentrations of ammonia do not interfere with the operation of the fuel cell choosing a temperature regimen is coherent with the kinetic properties of the decomposition catalyst and with the diffusion properties of the reactor backfilling.

The decomposition reaction is carried out in a catalytic reactor, the typical dimensions of which should be as small as possible. Reactor temperatures of around 600° C. are generally considered to be acceptable.

Ammonia usually is synthesized from hydrogen and nitrogen by using iron base catalysts, which allows carrying out the process at temperatures of from 350 to 450° C. Conversely, for ammonia decomposition it is better to use higher temperatures and other catalysts. According to the literature, the activity of metals which catalyze the decomposition of ammonia decreases as follows: Ru > Ni > Rh > Co > Ir > Fe >> Pt > Cr > Pd > Cu > Te, Se, Pb. Catalyst selection conditions may be formulated in the following sequence, by their importance:
Securing effective activity at temperatures from 500 to 600° C.
Securing a process initiation at a temperature of about 400-450° C.
Catalyst carrier size.
Catalyst carrier stability that ensures a long period of catalyst activity (several years).
Good accessibility and price of catalyst.

A key parameter for choosing energetic design parameters is the fuel cell efficiency coefficient, which is determined by the fraction of hydrogen that undergoes an electrochemical reaction when the decomposition gas mixture is passed through the fuel cell. As calculations demonstrate, at an effectiveness level of lower than 60% there is more than enough residual hydrogen for maintaining the temperature of the decomposition reactor and the requirements for thermal constructions are relatively simple. As the effectiveness of the fuel cell increases the energy reserves in the gases which leave the fuel cell decrease, which necessitates a more thorough approach for the design of the decomposition reactor. For alkaline type fuel cells the peak effectiveness around 70% is reached at temperatures close to 200° C. At least in cases where the effectiveness of the fuel cell is not significantly higher than 60% it is possible to create an installation, the temperature of which is maintained solely by the combustion of the exhaust gas mixture exiting the anode section of the fuel cell.

The heat required for carrying out the thermal decomposition of ammonia may be divided into three parts: evaporation of liquid ammonia, heating the vaporized ammonia up to the decomposition reaction initiation temperature, and decomposing the ammonia. Assuming a decomposition reaction initiation set point of 500° C. these three parts of required energy are approximately 20%, 20% and 60%. For ammonia evaporation a low temperature heat carrier may be used, thus making a practical realization relatively simple. For heating ammonia up to a decomposition initiation temperature of about 500° C. a heat carrier with an initial temperature of 600° C. is usually required. Most of the heat (energy) of the combustion gases has to be delivered to the reactor, the temperature of which will change within an only relatively narrow range, due to the consumption of energy by the (endothermic) decomposition reaction. This setting of heat exchange processes means that the heat exchange between the hot combustion gases and the reactor must be as effective as possible. If the combustion gases leave the reactor while overheated (i.e., the heat transfer from the combustion gases to the reactor is incomplete) retrieval of the residual energy in the combustion gases by the heat exchangers and its use in the process will be impossible. In that case additional combustion of ammonia will become necessary for maintaining the temperature of the reactor.

In view of the foregoing, it would be advantageous to have available an ammonia decomposition reactor in which the energy transfer from the combustion gases to the decomposition reactor is as efficient (complete) as possible.

### SUMMARY OF THE INVENTION

The present invention provides a process for the thermal decomposition of ammonia. The process comprises passing ammonia through a conduit (e.g., a pipe) which contains an ammonia decomposition catalyst in (only) a part thereof. At least a section of the part of the conduit which contains the catalyst (and preferably substantially the entire part which contains the catalyst) is immersed in molten lead which is at a temperature at which the catalyst is capable of catalyzing the decomposition of ammonia into hydrogen and nitrogen (for example, at a temperature of at least about 600° C., at least about 610° C., at least about 620° C., or at least about 630° C., depending on the catalyst).

In one aspect of the process, the molten lead may be present in a vessel whose outer wall is at least in part in direct contact with a hot gas whose temperature is higher than the temperature at which the catalyst is capable of catalyzing the decomposition of ammonia. For example, the hot gas may consist of or comprise a gas generated by the combustion of a gas or gas mixture which is or comprises hydrogen and/or ammonia, such as a gas mixture comprising hydrogen and nitrogen (and optionally, ammonia). For example, at least a part of the gas mixture containing hydrogen and nitrogen may be the exhaust gas of the anode part of a hydrogen fuel cell (e.g., an alkaline fuel cell) which had been supplied with a gas mixture generated by the thermal decomposition of ammonia (e.g., from the reactor in which the decomposition of ammonia is carried out). Further, at least a part of the gas mixture containing hydrogen and nitrogen for the generation of hot gas by combustion thereof may be a part of the decomposition gas mixture generated in the reactor in which the decomposition of ammonia is carried out (the remainder being fed to, e.g., a fuel cell). Of course, instead of or in addition to a hydrogen-containing gas mixture, a part of the ammonia earmarked for decomposition (generation of hydrogen) may also be combusted to provide hot combustion gas instead of being thermally decomposed inside the reactor.

In another aspect of the process, the hot gas may be passed through a gap between at least a part of the outer wall of the molten lead containing vessel and an inner wall of a thermo-isolated external casing or enclosure which completely surrounds at least a part of the molten lead containing vessel (and preferably substantially the entire vessel). Examples of suitable materials for the external casing are refractory materials such as those based on calcium oxide and silicon dioxide, materials made of refractory ceramic fibers or so-called aluminosilicate wool, and materials made of polycrystalline fibers. Corresponding materials are available from a wide range of suppliers, for example Allied Mineral Products (US). Morgan Advanced Materials (EU) or Luyang Unifrax Trading Company Limited (CN).

In yet another aspect of the process, the conduit may comprise a substantially U-shaped tube (made, e.g., of steel or any other alloy or metal which is resistant to the conditions of the decomposition reaction). It usually is preferred that more than one conduit (e.g., substantially U-shaped tube) is present in the vessel, such as, e.g., at least 2. at least 3, at least 4, at least 5 or at least 6 conduits (tubes) through which ammonia to be decomposed is passed. In this case the conduits may be the same or different, preferably the same.

In another aspect of the process, the at least one conduit may comprise a part which does not contain decomposition catalyst and through which ammonia to be decomposed is passed to heat it to a temperature which is suitable for contact with the decomposition catalyst which is present in another part of the conduit (preferably the decomposition reaction initiation temperature, such as, e.g., a temperature of at least about 450° C., at least about 460° C., at least about 470° C., at least about 480° C., or at least about 490° C., or at least about 500° C.). For example, at least a portion of the part of the conduit for heating the ammonia may be in direct contact with the hot gas generated by the combustion of a gas or gas mixture which is or comprises hydrogen and/or ammonia and had previously been in direct contact with the outer wall of the vessel which contains the molten lead.

In another aspect of the process, the decomposition products leaving the decomposition reactor may be passed to a hydrogen fuel cell to serve as fuel for the fuel cell.

In another aspect of the process, the ammonia decomposition catalyst in the at least one conduit may comprise one or more of Ru, Ni, Rh, Co, Ir, Fe, Pt, Cr, Pd or Cu, preferably Ru and/or Ni.

The present invention further provides a reactor which is suitable for (capable of) carrying out the process of the present invention as set forth above.

In one aspect of the reactor, the reactor may comprise a burner for generating a hot gas by combusting a hydrogen and/or ammonia containing gas or gas mixture (mixed with an oxygen containing gas such as air), a vessel containing lead and at least one conduit containing the ammonia decomposition catalyst in a part thereof. At least a section (and preferably the entirety) of the catalyst-containing part of the conduit may be surrounded by the lead present in the vessel, and a thermo-isolated external casing (enclosure) may completely surround at least a part of the lead-containing vessel such that there is a gap between an outer wall of the vessel and an inner wall of the external casing, through which gap the hot combustion gas can (must) pass.

In another aspect thereof, the reactor may further comprise at least one heating element which is at least in part immersed in the lead and capable of melting the lead before the vessel is contacted with the hot combustion gas.

In yet another aspect thereof, the reactor may further comprise a tank for holding liquid ammonia and a heating element which is capable of evaporating the ammonia which is to be thermally decomposed.

In a still further aspect, an outlet of the reactor (e.g., one end of the conduit) may be connected to an inlet of the anode part of a hydrogen fuel cell (e.g., an alkaline fuel cell).

In another aspect of the reactor, a gas inlet of the burner of the reactor may be connected to an exhaust gas outlet of the anode part of a hydrogen fuel cell (preferably the fuel cell which is supplied with the decomposition products of the reactor).

The present invention also provides a unit which comprises a hydrogen fuel cell and the ammonia decomposition reactor of the present invention as set forth above connected to each other.

The present also provides a method of increasing the energy efficiency of a reactor for the catalyzed thermal decomposition of ammonia. The method comprises supplying the energy required for maintaining the decomposition reaction by a stream of hot combustion gas. The energy is transferred from the hot gas to the ammonia and the decomposition catalyst not directly but through a mass of molten lead as efficient heat transfer medium which is heated by the hot gas and in turn heats the ammonia and the decomposition catalyst to thereby increase the amount of energy contained in the hot gas which can be used for heating the ammonia and the decomposition catalyst (e.g., due to the high capacity of lead to absorb and store heat).

### BRIEF DESCRIPTION OF THE DRAWINGS

The present invention is further described in the detailed description which follows, in reference to the accompanying drawings by way of non-limiting examples of exemplary embodiments of the present invention. In the drawings:

FIG. 1 schematically represents an ammonia decomposition reactor according to the present invention;

FIG. 2 is a schematic representation of the bottom part of an embodiment of the reactor according to the present invention;

FIG. 3 is a schematic representation of the top part of an embodiment of the reactor according to the present invention;

FIG. 4 shows an arrangement of (six) U-shaped tubes inside the lead containing vessel;

FIG. 5 shows a heating element for melting the lead in the lead containing vessel; and

FIG. 6 is a schematic top view of an embodiment of a decomposition reactor according to the present invention.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

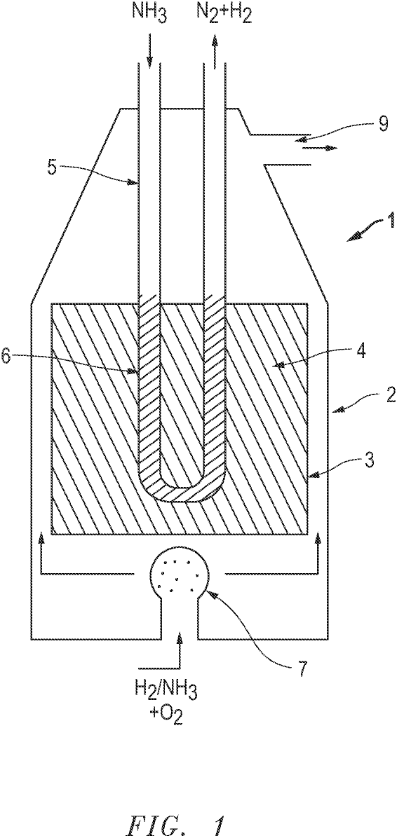

FIG. 1 schematically represents an ammonia decomposition reactor according to the present invention. The reactor 1 comprises an outer thermo-isolated casing 2 and a vessel 3 inside the casing which contains lead 4 in which a substantially U-shaped tube 5 containing an ammonia decomposition catalyst 6 in a part thereof is immersed. Ammonia is introduced at one end of the tube 5 and decomposition products exit the tube at the other end thereof. The reactor 1 further comprises a burner 7 (e.g., in the form of a torch) at the bottom thereof for the combustion of a hydrogen and/or ammonia containing gas (combined with an oxygen containing gas such as air). The hot combustion gas passes through the gap between the outer casing 2 and the vessel 3 and thereby maintains the molten lead 4 inside the vessel 3 at a temperature which is sufficient for maintaining the catalyzed decomposition reaction of the ammonia inside the tube 5. After having been in direct contact with the vessel 3 the hot gas comes into direct contact with that part of the tube 5 which does not contain catalyst in order to preheat the fresh ammonia introduced into the tube 5 at one end thereof, preferably to or close to a temperature which is suitable for contacting the catalyst 6 (i.e., the decomposition initiation temperature, which depends at least in part on the catalyst). Thereafter the combustion gas exits the reactor 1 through the gas outlet 9. The residual heat in this gas may optionally be used for other purposes, e.g., for evaporating liquid ammonia to be decomposed.

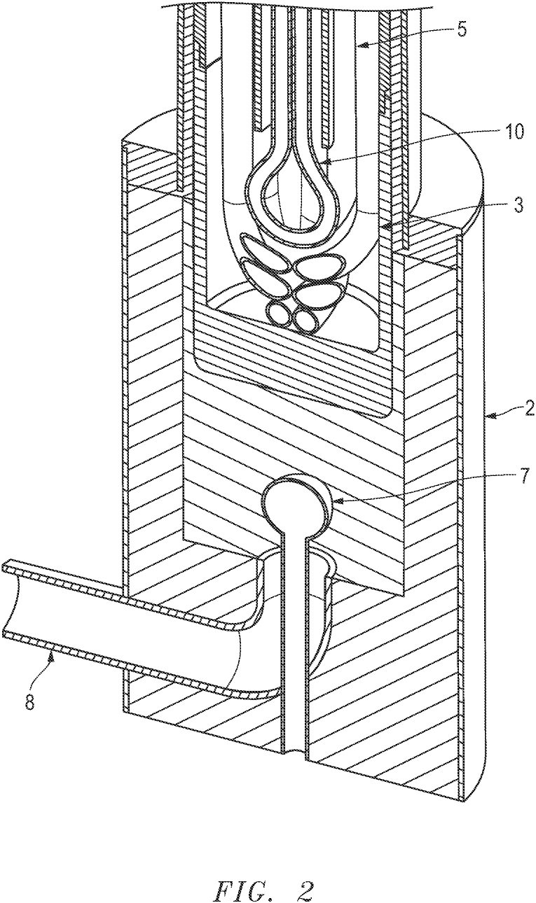

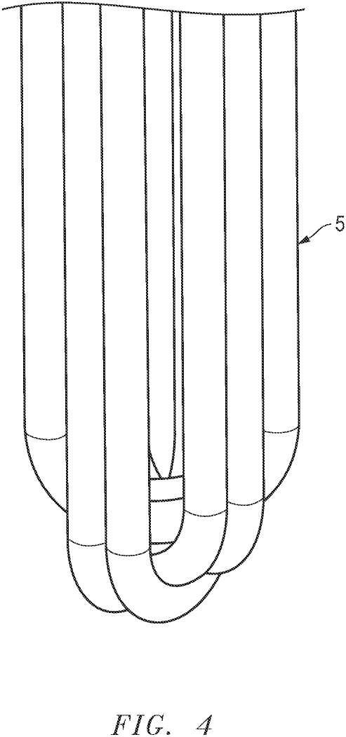

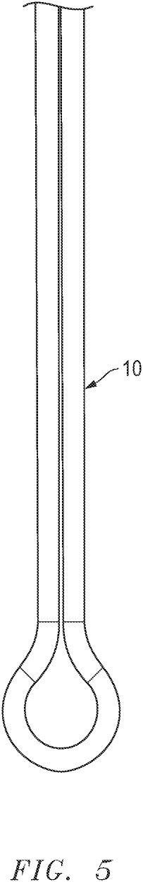

FIG. 2 is a schematic representation of the bottom part of an embodiment of the reactor according to the present invention. It shows, in addition to the elements discussed with respect to FIG. 1, an inlet 8 for the gas mixture that is to be passed to the burner 7. FIG. 2 further shows a vessel 3 which contains a total of six substantially U-shaped tubes 5, the arrangement of which inside the vessel 3 being shown in more detail in FIG. 4. FIG. 2 also shows a (preferably electric) heating element 10 inside the vessel 3, shown in more detail in FIG. 5. The heating element 10 can be used at the start of the process (at which the lead is usually at about room temperature and thus, a solid) to melt the lead (the melting point of lead is 327° C.). A suitable temperature of the heating element is, for example, about 500° C.

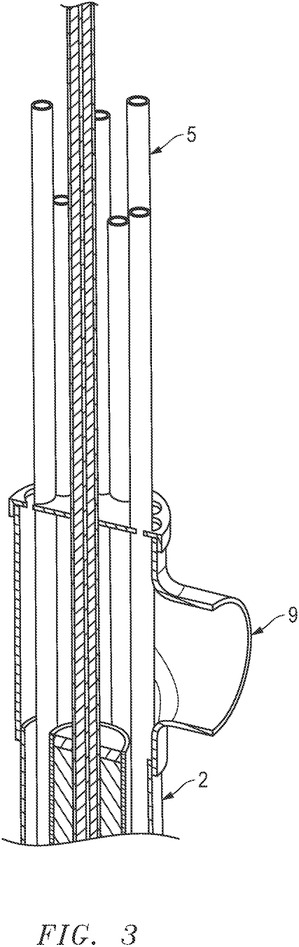

FIG. 3 is a schematic representation of the top part of an embodiment of the reactor according to the present invention. It shows the U-shaped tubes 5, the outer casing 2 and the outlet 9 for the hot combustion gas after heat transfer to the lead, catalyst and ammonia to be decomposed.

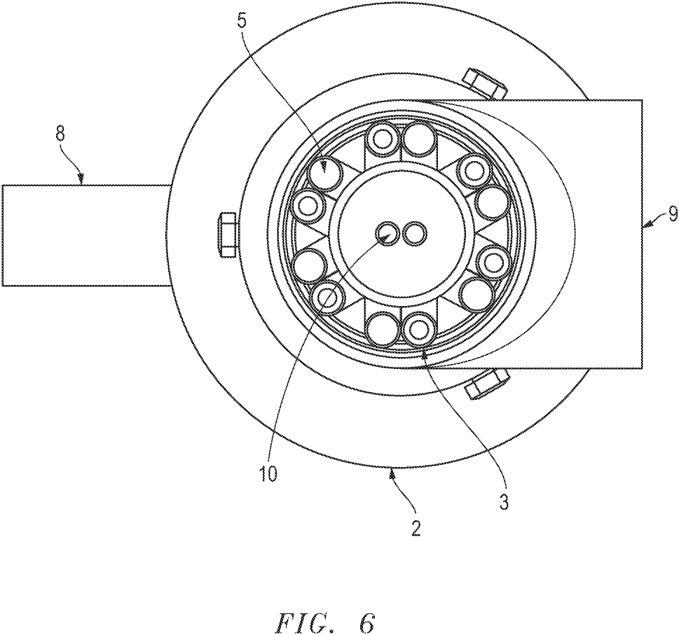

FIG. 6 is a schematic top view of an embodiment of the decomposition reactor according to the present invention. It shows the outer casing 2, the lead containing vessel 3, the inlets and outlets of the six tubes 5, the top of the heating element 10, the inlet 8 for the gases used for combustion and the outlet 9 for the hot combustion gas after heat transfer.

In the following an exemplary embodiment of a system which comprises the reactor-heat exchanger according to the present invention will be described in more detail. This embodiment comprises the following elements:
1. Reactor-heat exchanger.
2. Fan for supplying air into the burner (torch) of the reactor-heat exchanger.
3. External torch with a faucet and consumption measurement device for combustion Of hydrogen and/or ammonia containing gas;
4. Ammonia tank in water bath.
5. Electrical water heating element for bath of ammonia tank.
6. Consumption controller of gaseous ammonia.
7. Device for measuring hydrogen content in decomposition products (e.g., katharometer).
8. Computer with software for control and data acquisition.

The first step of launching the reactor-heat exchanger is turning on an electrical heating element for melting lead by setting the temperature of that element, for example to about 500° C. Heating control is carried out according to readings of a pair of thermocouples which sense the temperature at the bottom and at the top of the lead containing vessel. The temperature of the top thermocouple is higher than that of the bottom thermocouple during heating, which causes lead to melt from the top to the bottom, thereby preventing temperature tensions.

When proceeding towards reactor heating by means of burning hydrogen and/or ammonia containing gas the following sequence is followed: a minimal consumption (e.g., 14 volts) air supply fan is turned on, an ammonia tank is opened, the supply to the decomposition reactor is turned on with consumption of 0.5 nm³/hour and ignition of the internal burner is carried out by a gas torch through a special opening in the burning chamber. After the ignition, the opening is closed and further heating of the reactor is carried out according to readings of the thermocouples and a sensor of the hydrogen concentration in the decomposition products.

In order to accelerate heating, it is possible to gradually increase the supply of ammonia up to a consumption rate of 1.5-2 nm³/hour. Increasing consumption by 0.5 nm³/hour is possible when the hydrogen concentration in the gas leaving the reactor is higher than 30%. The heating process may be considered to be finished when readings of the thermocouple at the bottom of the lead containing vessel reaches 600° C.

### Testing of Reactor

The reactor was designed as an autonomous power source with a capacity of five kilowatts. Properties and advantages thereof were as follows:

1. A rapid decrease in the temperature of combustion products from an adiabatic combustion temperature (~ 1400° C.) to approximately 650° C., which is determined by the kinetic properties of the catalyst. As a result, almost all structural elements operate at temperatures below 650° C.

2. When using lower temperature catalysts, the operating temperature can still be reduced.

3. Liquid lead provides intensive heat exchange with the surfaces of tubes filled with a catalyst, enabling an almost isothermal mode of operation of a tubular reactor and a degree of decomposition of ammonia close to equilibrium.

4. The relatively low operating temperature of the structure contributes to the extension of its life and reduces heat loss to the environment.

In order to assess the thermal efficiency of the reactor tests were carried out at different ammonia consumption rates. Since the decomposition of ammonia is an endothermic reaction energy is required to maintain the working (decomposition) temperature. In addition, heat loss through thermal insulation is inevitable. At a fixed ammonia flow rate a part of the decomposition products was used as fuel in the combustion chamber of the reactor. In the experiments the minimum consumption of decomposition products which must be directed to the burner to maintain a stationary temperature was determined. To determine the minimum flow rate the following method was used. The decomposition products exiting the reactor were cooled to a temperature of 50° C. and were divided into two streams. One stream was sent to the burner of the reactor combustion chamber while the other stream was disposed of. The gas flow into the combustion chamber was measured using a flowmeter. This flow rate was reduced to the minimum value which still provided a high degree of ammonia decomposition. The test results are shown in the table below, in which in addition to the fraction of decomposition products used for combustion, four temperatures are set forth: T_{Pb_bott} and T_{Pb_up} = temperatures of the lead in the lower and upper parts of the reactor, T_{comb} = temperature of the combustion products, T_{H2_N2_out} = temperature of the decomposition products, and C_{H2} = volumetric concentration of hydrogen in the decomposition products.

The first line in the table refers to the “idle” mode, in which all decomposition products were combusted to heat the reactor. As the consumption of ammonia increased, the proportion of decomposition products used as fuel decreased. At a maximum productivity of 5 nm³/h of ammonia the decomposition costs and the heat losses amounted to 33% of the flow rate.

TABLE

| Consumption of NH₃, nm³/h | Fraction of decomposition products used for combustion, % | C_{H2}, % | T_{Pb}_{_bott}, °C | T_{Pb_up}, °C | T_{comb}, °C | T_{H2_N2_out}, °C |
|---|---|---|---|---|---|---|
| 0.25 | 100 | 74.7 | 616 | 606 | 332 | 104 |
| 0.5 | 72 | 74.72 | 629 | 620 | 336 | 124 |
| 1 | 43 | 74.8 | 630 | 618 | 313 | 162 |
| 2 | 38 | 74.8 | 645 | 630 | 307 | 217 |
| 3 | 35 | 74.75 | 650 | 640 | 340 | 272 |
| 4 | 34 | 74.6 | 660 | 647 | 382 | 320 |
| 5 | 33 | 74.6 | 670 | 655 | 396 | 358 |

1-25. (canceled)

26. A process for the thermal decomposition of ammonia, wherein the process comprises passing ammonia through a conduit which contains an ammonia decomposition catalyst in a part thereof, at least a section of the part of the conduit which contains the catalyst being immersed in molten lead as heat transfer medium which is at a temperature at which the catalyst is capable of catalyzing the thermal decomposition of ammonia into hydrogen and nitrogen.

27. The process of claim 26, wherein the molten lead is present in a vessel whose outer wall is at least in part in direct contact with a hot gas whose temperature is higher than the temperature at which the catalyst is capable of catalyzing the decomposition of ammonia.

28. The process of claim 27, wherein the hot gas is or comprises a combustion gas generated by the combustion of a gas or gas mixture which is or comprises hydrogen and/or ammonia.

29. The process of claim 28, wherein the gas mixture comprises hydrogen and nitrogen.

30. The process of claim 29, wherein at least a part of the gas mixture is an exhaust gas of an anode part of a hydrogen fuel cell which had been supplied with a gas mixture generated by the thermal decomposition of ammonia in the conduit.

31. The process of claim 26, wherein the exhaust gas is or comprises ammonia.

32. The process of claim 27, wherein the hot gas is passed through a gap between at least a part of the outer wall of the molten lead containing vessel and an inner wall of a thermo-isolated external casing which completely surrounds at least a part of the molten-lead containing vessel.

33. The process of claim 26, wherein the conduit comprises a substantially U-shaped tube.

34. The process of claim 26, wherein a plurality of conduits is used.

35. The process of claim 26, wherein the conduit comprises a part which does not contain decomposition catalyst and through which ammonia to be decomposed is passed to heat it to a temperature which is suitable for contact with the decomposition catalyst.

36. The process of claim 35, wherein at least a portion of the part of the conduit for heating the ammonia is in direct contact with hot gas generated by a combustion of a gas or gas mixture which is or comprises hydrogen and/or ammonia and had previously been in contact with the outer wall of a vessel which contains the molten lead.

37. The process of claim 26, wherein the process further comprises passing the decomposition products in the conduit to the anode part of a hydrogen fuel cell.

38. The process of claim 26, wherein the ammonia decomposition catalyst comprises one or more of Ru, Ni, Rh, Co, Ir, Fe, Pt, Cr, Pd or Cu.

39. The process of claim 26, wherein the ammonia decomposition catalyst comprises one or both of Ru and Ni.

40. A reactor for the thermal composition of ammonia, wherein the reactor is suitable for carrying out the process of claim 26.

41. The reactor of claim 40, wherein the reactor comprises a device for generating a hot gas by combusting a hydrogen and/or ammonia containing gas or gas mixture, a vessel containing lead and at least one conduit containing the ammonia decomposition catalyst in a part thereof, at least a section of the catalyst containing part of the conduit being surrounded by the lead present in the vessel, and a thermo-isolated external casing which completely surrounds at least a part of the lead-containing vessel such that there is a gap between an outer wall of the vessel and an inner wall of the external casing through which gap the hot gas can pass.

42. The reactor of claim 41, wherein the at least one conduit comprises a substantially U-shaped tube.

43. The reactor of claim 41, wherein the at least one conduit comprises a part which does not comprise catalyst and is capable of being heated by hot gas which had previously been in contact with the outer wall of the lead containing vessel to thereby heat ammonia gas entering the conduit to a temperature suitable for contacting the decomposition catalyst.

44. A unit, wherein the unit comprises a hydrogen fuel cell and the reactor of claim 26 connected to each other.

45. A method of increasing the energy efficiency of a reactor for the thermal decomposition of ammonia in the presence of a decomposition catalyst, wherein the energy required for maintaining the decomposition reaction is supplied by a stream of hot gas, the energy being transferred from the hot gas to the ammonia and decomposition catalyst through a mass of molten lead as heat transfer medium which is heated by the hot gas and in turn heats the ammonia and decomposition catalyst to thereby increase the amount of energy contained in the hot gas which is used for heating the ammonia and the decomposition catalyst.
